(19) United States
(12) Patent Application Publication
(10) Pub. No.: US 2013/0010967 A1
(43) Pub. Date: Jan. 10, 2013

(54) SPATIAL ANGLE MODULATION BINAURAL SOUND SYSTEM

(75) Inventors: Frederick H. Atwater, Faber, VA (US); Michael D. Turner, Huntsville, AL (US)

(73) Assignee: THE MONROE INSTITUTE, Faber, VA (US)

(21) Appl. No.: 13/177,262

(22) Filed: Jul. 6, 2011

(51) Int. Cl. H04R 5/00

(52) U.S. Cl. 381/1

(57) ABSTRACT

A method of inducing a state of consciousness in a listener. The method includes providing first and second sound signals. The first sound signal is provided to one ear of the listener and the second sound signal is provided to the other ear of the listener. The second sound signal is different from the first sound signal and, when provided with the first sound signal, first and second sound signals cause the listener to perceive a first source of sound that is moving about the listener or as a tremolo effect.

### TECHNICAL FIELD OF THE INVENTION

The present invention relates to binaural sound systems.

### BACKGROUND OF THE INVENTION

Transitioning between cognitive states in a human being is thought to require a stimulus. For example, to transition between a waking state and a sleeping state, an individual may close his/her eyes or rest in a supine position. The stimulus may be provided through any one of the five senses. In fact, it is well known that auditory stimuli may be used for achieving relaxation states. These auditory stimuli include, for example, sounds of nature, symphonic works, and tonal patterns.

Several tonal patterns have been conventionally used for establishing relaxation states. One example is an isochronic tone waveform 20, shown in FIG. 1, which includes a single tone that is pulsed on and off. The high contrast between the full tone “on” state and the silence of the “off” state, as illustrated on the timeline 22, is thought to be a strong stimulus to bring about a relaxation state. A related tonal pattern, the monaural beat waveform 24 illustrated in FIG. 2, produces a sound that is similar to the isochronic tone waveform 20 (FIG. 1) but without the strong contrast between on and off states. The monaural beat waveform 24 is generated by imposing a sine wave onto the emitted tone, or frequency, to generate variations in amplitude. The result is lower contrast but more pleasing sound. Because both the isochronic tone waveform 20 (FIG. 1) and the monaural beat waveform 24 (FIG. 2) are mono-channel, the tone therapy may be provided to the listener by a single speaker.

Binaural sound systems differ from mono-channel systems in that a different waveform is applied to each ear of the listener. One conventional binaural relaxation system, i.e., binaural beats, provides a first tone to one ear and a second tone to the other ear of the listener, where the frequencies of the first and second tones differ slightly. The listener perceives the interference between the two tones as a beating pattern. In the illustrative example of FIG. 3, a first tone 26 (here a 303 Hz frequency tone) is applied to one channel (i.e., ear) while a second tone 28 (here a 328 Hz frequency tone) is applied to the second channel. The listener's brain interprets the two tones 26, 28 as an interference pattern 30 having a beat with a frequency that is the difference between the frequencies of the first and second tones 26, 28, or about 25 Hz (303 Hz-328 Hz). The difference between the first and second tones 26, 28 should be less than 30 Hz, otherwise the brain will perceive two distinct tones instead of the beat pattern 30. The effects of binaural beating were first documented in 1839 and since have gained popularity for inducing a desired mental state, including relaxation, meditation, creativity, and so forth.

However, these conventional tonal patterns have limited flexibility. For example, each of the tonal patterns described above have two degrees of freedom: amplitude and beat pattern frequency. Furthermore, the binaural beat waveforms are limited to a small range of frequency differences. Therefore, the options available to the listener to tailor the particular tonal pattern to a specific need are quite limited. Thus, there exists a need for a tonal pattern that provides a greater number of options to the listener for tailoring the tonal pattern to achieve a desired result.

### SUMMARY OF THE INVENTION

In accordance with one embodiment of the invention, a method of inducing a state of consciousness in a listener is described. The method includes providing first and second sound signals. The first sound signal is provided to one ear of the listener and the second sound signal is provided to the other ear of the listener. The second sound signal is different from the first sound signal and, when provided with the first sound signal, the first and second sound signals comprising the binaural system cause the listener to perceive a source of sound that is moving about the listener or as a tremolo effect.

A binaural sound system is described in accordance with another embodiment of the invention. The binaural sound system includes a first sound signal that is comprised of a frequency that is modulated with a first phase to mimic repeated movement of a tone source through a spatial angle as it would be perceived by one ear of a listener or as a tremolo effect. The system further includes a second sound signal, which is also comprised of the same frequency used to generate the first sound signal but is modulated with a second phase that is different from the first phase, to mimic repeated movement of the tone source as perceived by the other ear of the listener or as a tremolo effect. Taken together, the first and second sound signals provide the perception of a binaural source of sound in repetitive motion spanning a certain spatial angle or as a tremolo effect. A plurality of such sound signals (including one signal for each ear) comprised of the one or more frequencies modulated with diverse phases may be added to the binaural sound system in a like manner. The plurality of sound signals provide the perception of a plurality of additional binaural sources of sound spanning diverse spatial angles or additional tremolo effects.

Another embodiment of the invention is directed to a method of altering a state of consciousness. The method includes disrupting a first state of consciousness in order to induce a desired second state of consciousness. Disrupting the first state includes listening to a binaural source of sound that is modulated with one or more spatial angles that are dissonant with the first state of consciousness. A second binaural source of sound, modulated with one or more spatial angles that are different from the first spatial angles, are selected that are consonant with the desired second state of consciousness. The second binaural source of sound slowly replaces the first and induces the desired second state of consciousness. Continued listening to the second binaural source of sound stabilizes the desired second state of consciousness. This embodiment may also be used to return to the first state of consciousness.

In still another embodiment of the invention, a binaural sound system is described that includes first and second sound signals supplied to first and second channels. The first sound signal is comprised of an emitted tone frequency. The second sound signal is also comprised of the emitted tone frequency but is phase shifted relative to the first sound signal.

### BRIEF DESCRIPTION OF THE FIGURES

FIG. 1 is an exemplary isochronic tone waveform in accordance with the prior art.

FIG. 2 is an exemplary monaural beat waveform in accordance with the prior art.

FIG. 3 illustrates the interference pattern formed in a binaural beat sound system in accordance with the prior art.

FIG. 4 is a schematic illustration of the perception of sound emitted from a point source of sound by each ear of a listener.

FIG. 5 is a flowchart illustrating one method of generating a binaural sound system in accordance with one embodiment of the invention.

FIG. 6A is a schematic illustration of an open sound path and a method of calculating a binaural sound system waveform in accordance with one embodiment of the invention.

FIG. 6B is a schematic illustration of a closed sound path.

FIG. 6C is a schematic illustration of a discontinuous sound path.

FIG. 7 is a schematic illustration of the components of a binaural sound system.

FIG. 8 is a schematic illustration of the perceived movement of sound by a listener of a binaural sound system according to one embodiment of the invention.

FIG. 9 is a flowchart illustrating one method of altering a state of consciousness using a binaural sound system in accordance with one embodiment of the invention.

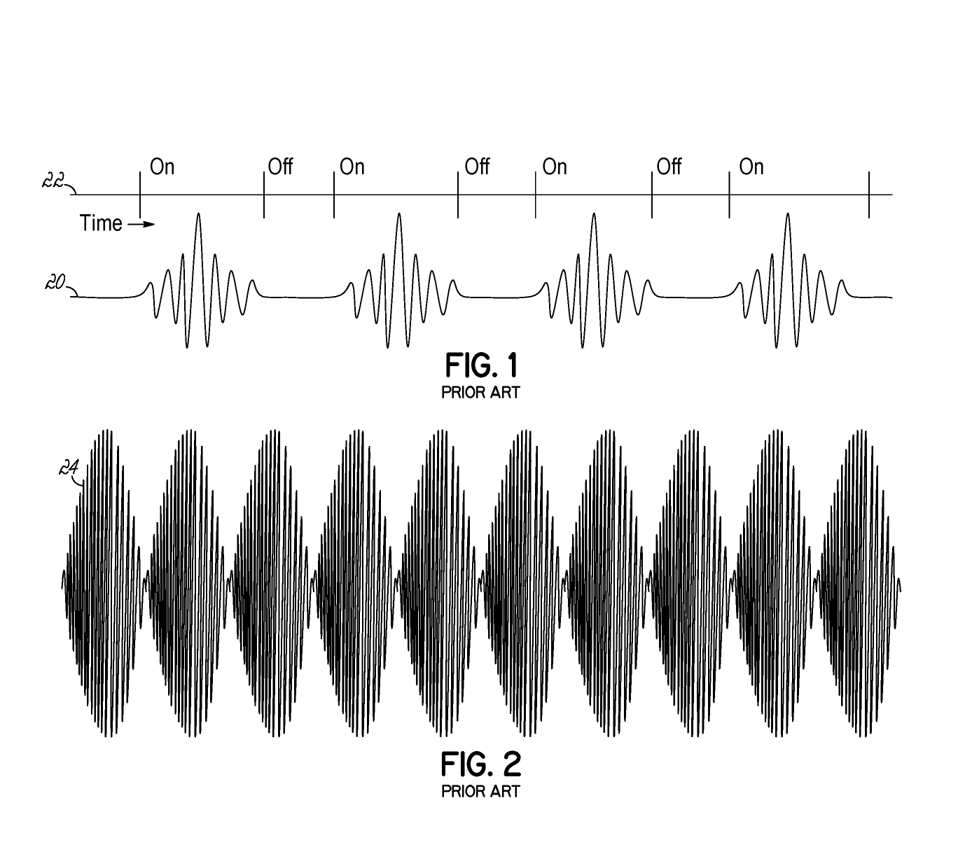

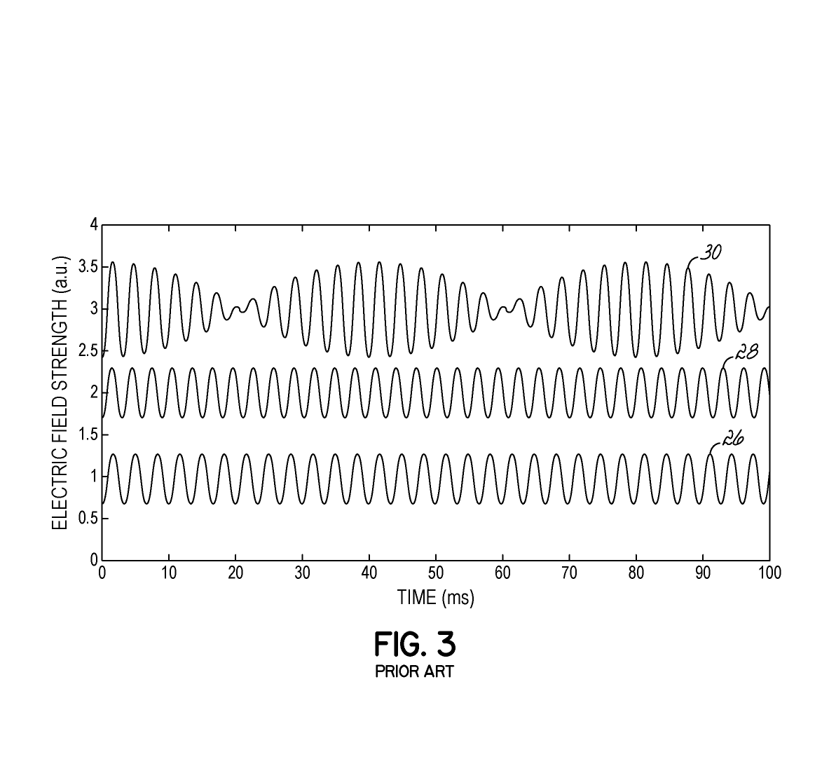

### DETAILED DESCRIPTION

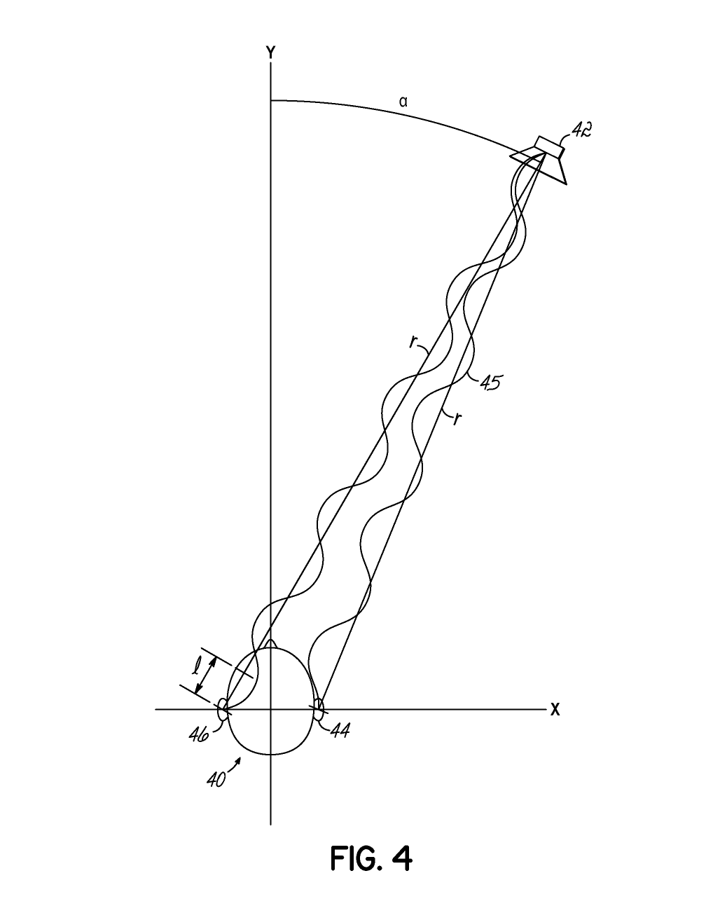

Turning now to FIGS. 4-9, a spatial angle modulation binaural sound (“SAM binaural sound”) is described in accordance with one embodiment of the invention. The SAM binaural sound is applied to both ears of the listener and is configured to cause the listener to perceive a point source of sound moving relative to the listener. In some embodiments the moving sound is perceived to follow a sound path; in other embodiments, the moving sound is perceived as a tremolo effect. In still other embodiments, the movement of the sounds is not perceived as a naturally-occurring movement.

FIG. 4 illustrates the mechanism by which a listener 40 perceives the movement of a sound. For convenience of discussion, the listener 40 is positioned at the origin of the coordinate system and a point source of sound 42 configured to emit the perceived sound is positioned within the first quadrant of the coordinate system. While a Cartesian coordinate system is illustrated, it would be understood that this is for illustrative convenience and that any coordinate system, such as a spherical or polar coordinate system, may be used as desired. Furthermore, it is understood that while the point source of sound 42 is specifically illustrated as a speaker, the sound may be emitted from a device other than a speaker and may, in fact, be electronically generated or simulated by a computer, as described in greater detail below.

The sound that is emitted by the point source 42 travels a first distance, r, from the point source 42 to the listener's right ear 44. Because the right and left ears 44, 46 are separated by a finite distance (anatomically ranging from about 15 cm to about 25 cm), the sound emitted by the point source 42 travels a second distance, r+l, to the left ear 46. It would be readily appreciated by those of ordinary skill in the art that the difference in distance, l, depends on the angle, α, of the point source 42 relative to an axis extending forward and away from the listener 40, which in FIG. 4 is coincident with the y-axis. As a result of the anatomical distance between the right and left ears 44, 46, the sound that is emitted by the point source 42 travels from the point source 42, through the air at about 343 m/s, and reaches the listener's right ear 44 before reaching the left ear 46. This slight difference in time allows the listener 40 to identify the location, or direction, of the sound. In other words, as the sound (an emitted frequency 45) travels toward the listener 40, the phase of the waveform of the emitted frequency 45 received by the right ear 44 is slightly different than the phase received by the left ear 46. The slight difference in phase is perceived and interpreted as the direction of the sound. The opposite analysis would be true for a point source 42 that is located in the fourth quadrant (or to the upper, left hand side of the listener 40). Furthermore, if the point source 42 moves in the space surrounding the listener 42, the relative distances between the point source 42 and the left and right ears 46, 44 of the listener 40 change, and the listener 40 perceives the moving sound.

The SAM binaural sound utilizes this effect to simulate or otherwise generate two waveforms, as described in detail below, that when played back to the listener 40, will cause the listener 40 to perceive a sound that is external to the listener 40 and moving about the listener 40.

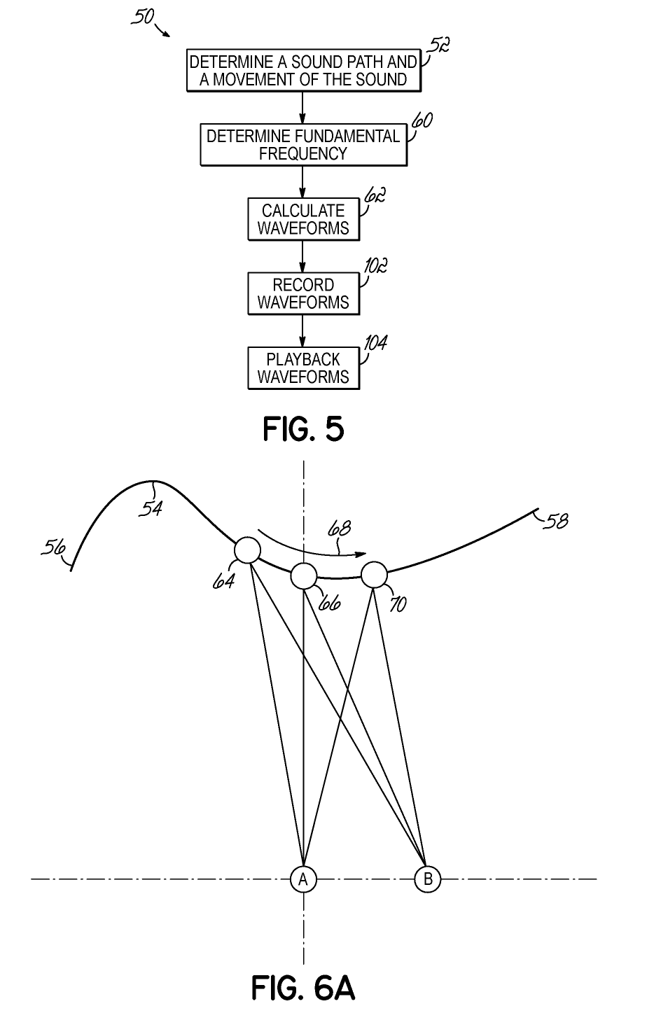

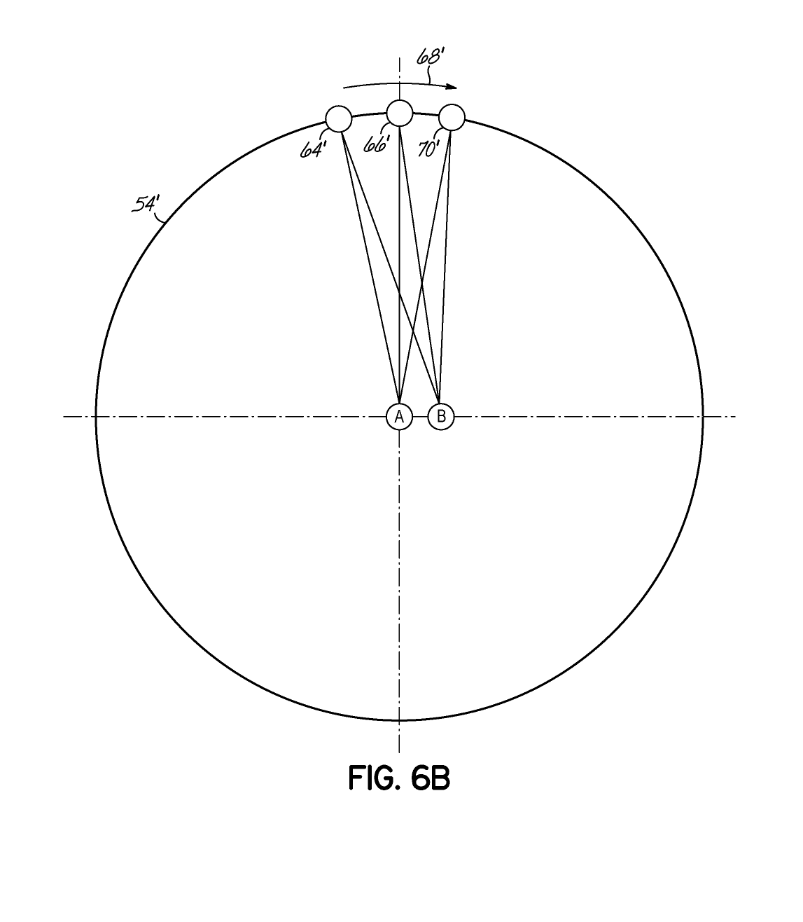

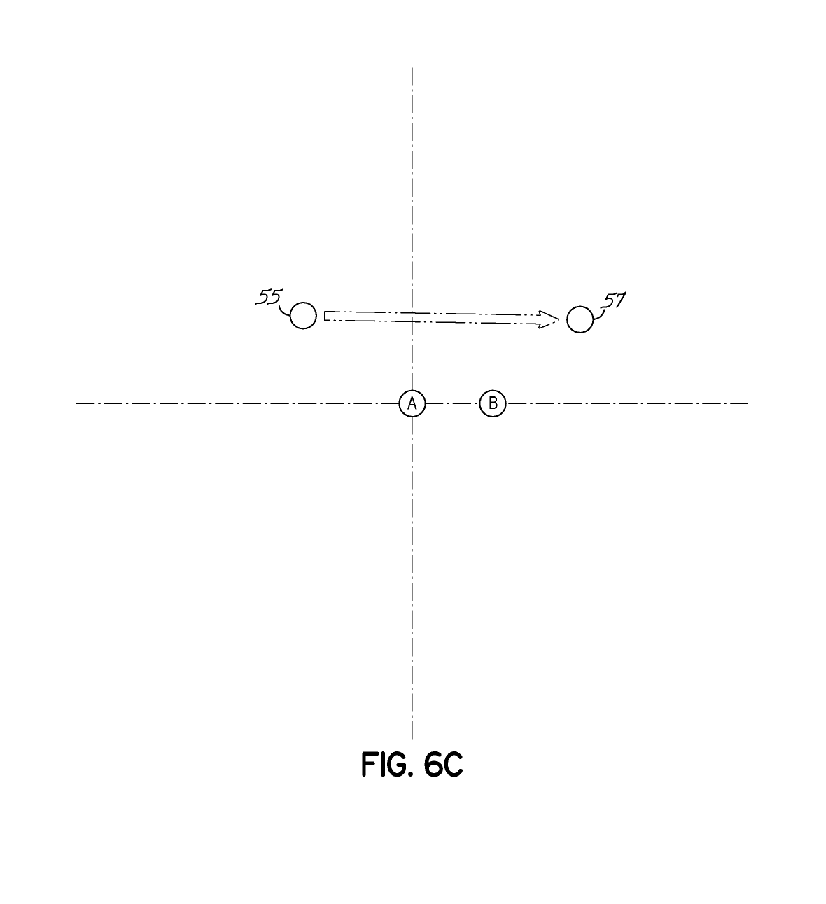

One exemplary method of generating a SAM binaural sound is explained with reference to FIGS. 5, 6A, and 6B with continued reference back to FIG. 4. For example, in the flowchart of FIG. 5, the method 50 begins with determining a shape of a sound path relative to the listener 40 (Block 52). The sound path relative to the listener 40 may be, but is not limited to, one which follows a circular path around the listener 40 as such in FIG. 4, where the arc “α” is extended around the listener 40 to form a circle. While the sound path may include any shape, in FIGS. 6A and 6B the sound paths are generally curvilinear, that is without any abrupt changes in direction or is considered to be a continuous function. In yet other embodiments, such as the embodiment illustrated in FIG. 6C, the sound path is discontinuous, or includes at least one non-continuity that results in an abrupt change in the direction and/or position of the point source 42. Specifically, in FIG. 6C, the point source 42 would be perceived to repeatedly move (illustrated by a phantom arrow), or perceived as to jump, between a first position 55 within the fourth quadrant and a second position 57 within the first quadrant without existing in the space between the first and second positions 55, 57; however, in other embodiments, a plurality of positions may be included so that the sound moves between the plurality of positions. The movement between the plurality of positions may be in accordance with a previously determined pattern or at random.

Returning again to FIG. 6A with reference to FIG. 4, the shape of the sound path 54 is illustrated as curvilinear and having a first terminal point 56 and a second terminal point 58. That is, the sound path 54 is an open path, i.e., the sound path 54 does not fully surround the listener 40. The sound path 54 may be equally distributed between the left and right sides of the listener 40 or the sound path 54 may be primarily located on one side of the listener 40. The point source of sound 42 moving along the sound path 54 of FIG. 6A would repeatedly travel between the first and second terminal points 56, 58, and may be said to oscillate along the sound path 54.

By contrast, the shape of the sound path 54′ in FIG. 6B forms a closed path, i.e., fully surrounding the listener 40. Examples of closed paths may include, for example, circles, ovals, and ellipses; however, irregular shapes may also be used. The listener 40 may be positioned at the center or a focus of the closed path 54′ or the listener 40 may be offset from the center or focus such that the listener 40 is closer to a first portion of the closed path 54′ than a second portion of the closed path 54′.

It would be understood that while the illustrative sound paths 54, 54′ are planar, that is, residing within a common plane relative to the listener 40 (FIG. 4), the shape of the sound path 54, 54′ need not be so limited. Instead, the shape of the sound path 54, 54′ may extend into three-dimensions. Furthermore, the shape, size, and location of the sound path 54, 54′ may be selected to achieve a localized effect within the brain, i.e., to selectively stimulate one portion of the brain as compared to another portion of the brain. In those embodiments where the sound path 54, 54′ surrounds the listener 40 (FIG. 4), that is, the sound path 54, 54′ is equally distributed between the left and right sides of the listener 40 (FIG. 4), the listener 40 (FIG. 4) may achieve a state of focus or awareness due to the equal stimulation of both hemispheres of the brain. By equally stimulating both hemispheres, communication across the corpus callosum increases and the listener 40 (FIG. 4) may perceive a greater state of awareness. Though not specifically shown, in other embodiments where the sound path 54, 54′ predominantly or fully resides on one side of the listener 40 (FIG. 4), then one hemisphere of the brain is stimulated to a larger extent than the other hemisphere. For example, a sound path 54, 54′ residing predominantly to the right of the listener 40 (FIG. 4) would stimulate the left hemisphere to a larger degree than the right hemisphere because the acoustical neurons associated with the right ear largely terminate within the left hemisphere. As a result, hemispheric specialization within the brain may be achieved. In still other embodiments, multiple sound paths and/or frequencies of emitted tones may be used to specifically stimulate a particular cortical region, bilaterally or unilaterally.

Furthermore, while not shown, it would be understood that the sound path 54, 54′ need not be limited to distances that are spaced from the listener 40 (FIG. 4). Instead, the sound path 54, 54′ may come into close proximity with the listener 40 (FIG. 4), cross over the listener 40 (FIG. 4), or extend through the listener 40 (FIG. 4) such that the point source 42 (FIG. 4) is perceived to move immediately external to or even traverse the listener 40 (FIG. 4).

Movement of the point source of sound 42 (FIG. 4) on the sound path 54, 54′ may be described in terms of frequency or angular motion. In other words, the movement may be described as the repeated movement back and forth on the open sound path 54 in FIG. 6A or one-directional movement on the closed sound path 54′ per unit time in FIG. 6B, e.g., frequency. Still in other embodiments, it may be appropriate to describe the movement as sweeping through angles along a generally circular, oval, elliptical, semi-circular, semi-oval, or semi-elliptical sound path 54, 54′, i.e., angular movement. Therefore, Block 52 further includes determining the desired frequency, angular momentum, or other measurement of the movement of the point source 42 (FIG. 4).

Further, the perceived movement of the sound may be variable. That is, the point source of sound 42 (FIG. 4) may be perceived as accelerating, decelerating, or both as it moves on the sound path 54, 54′. However, this variance is not necessary and, for simplicity of description herein, a point source of sound 42 (FIG. 4) perceived to be moving at a constant frequency or angular motion will be described.

With sufficient frequency or angular motion, movement of the point source of sound 42 (FIG. 4) may be perceived as a tremolo (or a warbling) instead of a point source of sound 42 (FIG. 4) moving in space along a predetermined sound path 54, 54′. It will be readily appreciated that movement of the point source 42 (FIG. 4) is not limited to a particular range of frequencies. As was described in detail above, the conventional binaural beats method is fundamentally limited to frequencies that differ by less than 30 Hz. Because the perceived tremolo of the SAM binaural sound system is dependent only on the perceived movement of the point source 42 (FIG. 4), the SAM binaural sound system is not limited to 30 Hz and other frequency ranges may be used. For example, the SAM binaural sound system may be applied to other frequencies, such as those within the gamma frequency range (i.e., ranging from about 40 Hz to about 70 Hz). Gamma brainwaves have the smallest amplitude on an electroencephalographygraph (“EEG”) in comparison to the other four basic brainwave frequencies (delta, theta, alpha, and beta) and have been considered to be associated with cognitive brainwaves related to intelligence, self-control, and feelings of compassion and/or happiness. Therefore, the SAM binaural sound system may be tuned, or tailored, to the gamma frequency range and specifically address these brainwaves.

With the sound path 54, 54′ and the movement of the point source 42 (FIG. 4) determined, the tone emitted by the point source 42 (FIG. 4) is determined (Block 60). Generally, this may be a pleasing tone, for example, the frequency 300 Hz or the frequency 440 Hz (for the note A above middle C) are each conventionally considered to be pleasing and relaxing; however, others tones may be possible. The emitted tone may be a sine wave having the form:

y=A sin(wt+φ)

where A is the amplitude, w is the angular frequency (generally reported in radians per second), t is time, and φ is the phase of the sine wave; though other waveform shapes may be used for creating the tone. Angular frequency is related to the frequency here by w=2πf.

With the emitted tone and the waveform determined, and in accordance with one embodiment of the invention, the emitted tone may be modulated to generate two waveforms to achieve the binaural effect (Block 62). For example, when a sound source is in motion relative to a listener, a perceived shift in frequency occurs for the listener, i.e., the Doppler Effect, which is a well known effect in the fields of audio, physics, and engineering and is described in detail in several text books. See, for example, David Halliday et al., Fundamentals of Physics Extended (John Wiley and Sons 9^{th} ed. 2010). Therefore, it will be obvious to one of ordinary skill in the art that, when the sound source emitting a pure tone of a given frequency is in relative motion toward the listener, the pure tone is perceived by the listener at a higher or increased frequency compared with the actual pure tone emitted by the sound source. Similarly, when the sound source is in relative motion away from the listener, the pure tone is perceived by the listener at a lower or decreased frequency compared with the actual pure tone emitted by the sound source.

FIGS. 6A and 6B, with reference to FIG. 4, schematically illustrate this effect with movement of the point source of sound 42 along the determined sound path 54, 54′ relative to a single ear of the listener 40. While these figures illustrate physical movement of the point source of sound 42 on the sound path 54, 54′, the movement may be otherwise simulated, or otherwise electronically generated, such as by phase modulation, as described in detail below. For convenience, point A representing the left ear 46 of the listener 40 is positioned at the origin of this Cartesian coordinate system, but another coordinate system may alternatively be used. The illustrative example includes a stationary point A because the listener 40 will generally listen to the final SAM binaural sound system through headphones and movement of the listener 40 will thus be irrelevant. However, it would be readily understood that movement of the listener 40 relative to the point source of sound 42 may otherwise be incorporated if a sound device besides headphones is to be used.

Referring specifically to FIG. 6A, movement of the point source 42 may proceed from a first position 64 on the sound path 54 to a second position 66 on the sound path 54 that is spaced away from the first position 64 by a first discrete interval and in a direction indicated by the arrow 68. The movement from the first position 64 to the second position 66 brings the point source 42 closer to point A and the listener 40 will perceive a higher tone as compared to the emitted tone as the point source 42 travels over this first discrete interval. Continued movement of the point source 42 to a third position 70 along the sound path 54 causes the point source 42 to move farther from point A and the listener 40 will perceive a lower tone as compared to the emitted tone as the point source 42 travels over this second discrete interval. In reality, the emitted tone is unchanged but the phase of the emitted tone causes the perceived frequency received at point A to differ as described in detail above.

Contrasting this now with point B, which is representative of the right ear 44 of the listener 40, movement of the point source 42 from the first position 64 to the second position 66 over the first discrete interval will bring the point source 42 closer to point B. Further movement of the point source 42 (FIG. 4) to the third position 70 on the sound path 54 brings the point source 42 closer still to point B. Thus, point B will perceive a higher tone for the full movement of the point source 42 along the sound path 54 between the first, second, and third positions 64, 66, 70. Again, the perceived effect is a change in the frequency of the emitted tone; however, the emitted tone is unchanged. Instead, it is the change in the relative phase of the emitted tone from each position 64, 66, 70 as received at point A that affects the perceived tone. The relative change in the phases received at both points A and B provides the perceived movement change and the binaural effect.

With respect to FIG. 6B (with reference to FIG. 4), point A is positioned at the midpoint of the circular sound path 54′. As a result, the point source 42 remains equidistant from point A as it moves along the sound path 54′, and for example, between the first, second, and third positions 64′, 66′, 70′. Yet, movement of the point source 42 along the sound path 54′ will be perceived because of the binaural effect created with respect to point B. Movement of the point source 42 from the first position 64′ to the second and third positions 66′, 70′ brings the point source 42 closer to point B. Thus, while point A perceives no change in the emitted tone, point B perceives a higher tone as compared with the emitted tone. Or said another way, the phase of the emitted tone that is received at point B changes relative to the phase received at point A, where the phase remains constant with respect to the emitted tone. The combined effect is that the point source 42 is perceived to move in the space in front of the listener 40 from the left to the right.

The movement perceived by each of the left and right ears 46, 44, or Points A and B as shown in FIGS. 6A and 6B, may be calculated at a plurality of positions along the sound path 54, 54′. Generally, the positions are separated by a constant, discrete interval of time; however, this is not necessary. Furthermore, it would be understood that increasing the number of positions comprising the above plurality, i.e., decreasing the length of the discrete intervals, increases the perceivable spatial resolution of the sound path 54 54′.

Because the point source of sound 42 repeatedly moves along the same sound path 54, 54′ (i.e., reciprocating movement between the first and second terminal points 56, 58 of the sound path 54 of FIG. 6A or cyclical movement on the sound path 54′ of FIG. 6B), the point source of sound 42 is considered to oscillate. The resultant waveform representative of the movement of the point source 42 will be periodic in nature with respect to time. In one exemplary embodiment for a sound path, such as the sound path 54′ of FIG. 6B having a circular or semi-circular-shape, the signal provided to each channel may be determined to be:

S_{L}(t)=A·sin [2πf_{S}t+φₚ sin(2πfₘt)+φ_{L}]

S_{R}(t)=A·sin [2πf_{S}t−φₚ sin(2πfₘt)+φ_{R}]

where S_{L} and S_{R} are the signals applied to the left and right channels, respectively, A is the signal amplitude, fₛ is the frequency emitted by the point source 42, t is time, φₚ is the peak value of phase deviation of the signals, fₘ, is the frequency of spatial oscillation of the point source of sound 42 along the sound path 54′ (corresponding to the frequency of the tremolo or warbling effect), and φ_{L} and φ_{R} are the absolute phase offsets of the left and right channels, respectively. The peak value of phase deviation is related to the change in differential distance from the point source of sound 42 to each ear 44, 46 of the listener 40 as the point source 42 travels along the sound path 54′. The absolute phase offsets may be used, together, to control the direction to a midpoint of the sound path 54′ relative to both ears 44, 46.

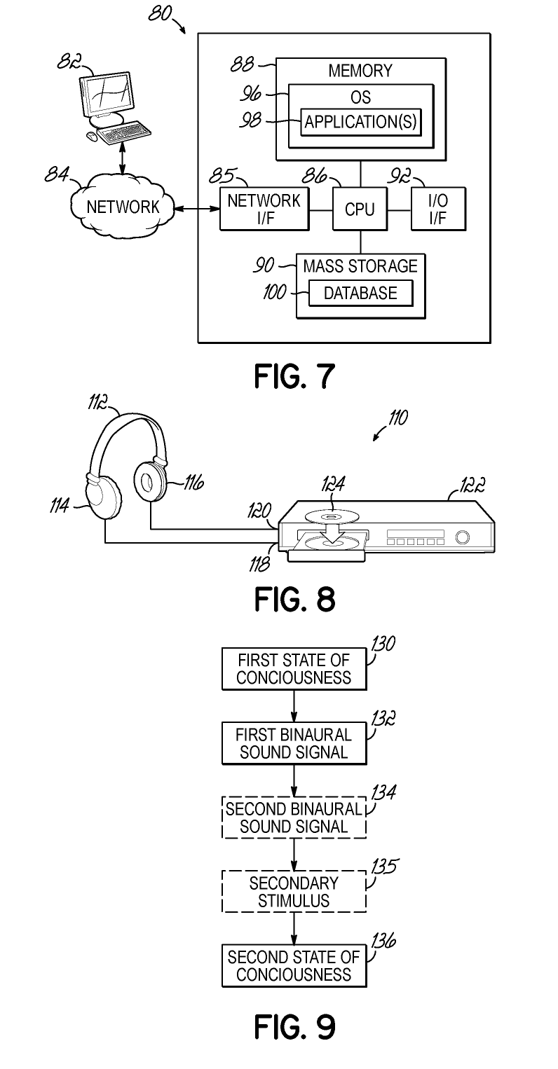

These determinations and calculations of the waveforms for the SAM binaural sound may be performed on a computer 80, one suitable embodiment of which is shown in FIG. 7. The computer 80 that is shown in FIG. 7 may be considered to represent any type of computer, computer system, computing system, server, disk array, or programmable device such as multi-user computers, single-user computers, handheld devices, networked devices, etc. The computer 80 may be implemented with one or more networked computers 82 using one or more networks 84, e.g., in a cluster or other distributed computing system through a network interface (illustrated as “NETWORK I/F” 85). The computer 80 will be referred to as a “computer” for brevity's sake, although it should be appreciated that the term “computing system” may also include other suitable programmable electronic devices consistent with embodiments of the invention.

The computer 80 typically includes at least one processing unit (illustrated as “CPU” 86) coupled to a memory 88 along with several different types of peripheral devices, e.g., a mass storage device 90, an input/output interface (illustrated as “I/O I/F” 92), and a Network I/F 85. The memory 88 may include dynamic random access memory (DRAM), static random access memory (SRAM), non-volatile random access memory (NVRAM), persistent memory, flash memory, at least one hard disk drive, and/or another digital storage medium. The mass storage device 90 is typically at least one hard disk drive and may be located externally to the computer 80, such as in a separate enclosure or in one or more networked computers 82, one or more networked storage devices (not shown but including, for example, a tape drive), and/or one or more other networked devices (not shown but including, for example, a server).

The CPU 86 may be, in various embodiments, a single-thread, multi-threaded, multi-core, and/or multi-element processing unit (not shown) as is well known in the art. In alternative embodiments, the computer 80 may include a plurality of processing units that may include single-thread processing units, multi-threaded processing units, multi-core processing units, multi-element processing units, and/or combinations thereof as is well known in the art. Similarly, the memory 88 may include one or more levels of data, instruction, and/or combination caches, with caches serving the individual processing unit or multiple processing units (not shown) as is well known in the art.

The memory 88 of the computer 80 may include an operating system (illustrated as “OS” 96) to control the primary operation of the computer 80 in a manner that is well known in the art. The memory 88 may also include at least one application 98, or other software program, configured to execute in combination with the operating system 96 and perform a task, such as calculating the waveforms as described above with or without accessing further information or data from a database 100 of the mass storage device 90.

In general, the routines executed to implement the embodiments of the invention, whether implemented as part of the operating system 96 or a specific application, component, algorithm, program, object, module or sequence of instructions, or even a subset thereof, will be referred to herein as “computer program code” or simply “program code.” Program code typically comprises one or more instructions that are resident at various times in the memory 88 and/or the mass storage devices 90 in the computer 80, and that, when read and executed by the CPU 86 in the computer 80, causes the computer 80 to perform the processes necessary to carry out elements embodying the various aspects of the invention.

Those skilled in the art will recognize that the environment illustrated in FIG. 7 is not intended to limit the present invention. Indeed, those skilled in the art will recognize that other alternative hardware and/or software environments may be used without departing from the scope of the invention.

Returning again to FIG. 5 and with continued reference to FIG. 7, the calculated waveforms may then be recorded onto a fixed medium for playback (Block 102). For example, the mass storage device 90 may be operable to record, burn, or otherwise imprint the calculated waveforms onto the appropriate fixed medium, including compact disc (“CD”), digital video disc (“DVD”), or other portable, external mass storage device and may be stored in either a compressed format (such as MP3 and WMA as a few examples) or an uncompressed format (examples include WAV and PCM).

With the waveforms generated and recorded (Blocks 62, 102), and with reference now to FIGS. 5 and 8, the waveforms are ready for playback to the listener 40 (Block 104). One exemplary sound system 110 suitable for playback of the SAM binaural sound is shown in FIG. 8 and includes headphones 112 with isolated left and right channels 114, 116 so as to reduce the amount of cross-talk that may occur between channels 114, 116. However, other embodiments are possible, such as sound domes that are designed to create left/right sound isolation. In the instant embodiment, the headphones 112 are plugged into left and right channel outputs 118, 120 of a stereo 122, which may be any commercially-available personal sound system (for example, including personal computers, smart phones, personal CD players, MP3 players, and the like) or a commercially-available audio sound system having a receiver, a CD player, an MP3 player, and so forth. In any event, the stereo 122 is configured to playback the waveforms from the file format and mass storage device (CD 124 is shown) on which the waveforms are recorded.

FIG. 9 is a flowchart illustrating one method of using the SAM binaural system to achieve an altered state of consciousness in accordance with one embodiment of the invention and with reference to FIG. 4. The listener 40, in a first state of consciousness (for example, awake), places the headphones 112 (FIG. 8) onto his/her head (Block 130) and initiates playback. The SAM binaural system provides a first binaural sound signal comprised of first and second waveforms to each of the left and right channels 114, 116 (FIG. 8), respectively, of the headphones 112 (FIG. 8) (Block 132). The first and second waveforms are based on the same emitted tone but each is modulated with a different phase such that the listener 40 perceives a moving tone. The first binaural sound signal may be looped a desired number of times or for a desired length of time. For example, if the curvilinear sound path 54 (FIG. 6A) is used, then the point source 42 may continue to move between the two terminal points 56, 58 (FIG. 6A) a number of times to fill the desired loop or time. If desired, a second binaural sound signal may be included or introduced (Block 134). The second binaural sound signal may be superimposed with a portion of the first binaural sound signal or may follow the first binaural sound signal once the first binaural sound signal loop is complete. The second binaural sound tone may include a different emitted tone as compared to the emitted tone of the first binaural sound signal, may have a different sound path as compared to the sound path of the first binaural sound signal, or a combination thereof, and may also be looped as described above. In other embodiments, the first binaural sound signal, the second binaural sound signal, or both may include a plurality of tones (of varying frequency and/or sound path) used in series, parallel, or other desired combination.

If so desired, a secondary stimulus may also be provided (Block 135). The secondary stimulus may include music, pleasing natural background sounds (surf, rain, wind, etc.), artificially-generated background sounds (pink sound, brown sound, etc.), other tonal patterns, and/or verbal guidance in the form of narrative inserts. Still other examples of secondary stimulus may further include environmental effects (for example sitting in a darkened room), social-psychological affects (intra-group affirmation, affinity, and/or communication), or learned skills (breathing techniques, visualization, etc.). The secondary stimulus may be provided before, during, or after the first and/or second binaural sound signals, or a combination of the same.

With playback complete, the listener 40 has reached a second state of consciousness (for example, sleep, focused attention, relaxation, creativity, etc.) (Block 136).

While the SAM binaural sound has been described with reference to the phase-delayed perceived differences between the left and right ears 44, 46, it would be understood that simulated sound environments need not be so limited. Instead, the relationship between the phase-delay of one ear relative to the other ear may be configured to fall within ranges that are beyond those that are conventionally perceived with real audio systems. Said another way, the conventional perception of sound includes a phase delay related to the anatomical distance between the listener's ears 44, 46; however, the SAM binaural sound is not limited to these anatomically-based perceived delays. Instead, the phase-delay may be simulated to be greater than those that occur due to anatomical structure with naturally-occurring sounds. The result is a tremolo effect that is difficult to consciously perceive or delineate as movement as there is no naturally-occurring equivalent. The SAM binaural sound is a tonal pattern sound system having a wide range of flexibility. Specifically, the SAM binaural sound provides six degrees of freedom (amplitude, emitted frequency, modulation frequency, peak phase deviation, and absolute phase offsets for each channel) that allow the SAM binaural sound to be customized and/or optimized to achieve a desired effect for the listener 40. The flexibility afforded by the SAM binaural sound system enables the listener 40 to more easily access a wide variety of states of consciousness with a more reliable method that yields a faster response time for the listener 40. Also, the SAM binaural sound provides a deeper immersion during the stabilization of the conscious state as compared to other audio-guidance, tonal pattern technologies.

While the present invention has been illustrated by a description of various embodiments, and while these embodiments have been described in some detail, they are not intended to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with methods of practicing the present invention as currently known. However, the invention itself should only be defined by the appended claims.

What is claimed is:

1. A method of inducing a state of consciousness in a listener comprising:
providing a first sound signal to one ear of the listener; and
providing a second sound signal to the other ear of the listener, wherein the second sound signal is different from the first sound signal and when provided with the first sound signal causes the listener to perceive a first source of sound moving about the listener.

2. The method of claim 1, wherein a phase of at least one portion of the first sound signal differs from a phase of a corresponding portion of the second sound signal.

3. The method of claim 1, wherein a phase of the first sound signal is shifted with respect to a phase of the second sound signal.

4. The method of claim 1, wherein the movement of the first source of sound is perceived as a tremolo effect.

5. The method of claim 1, wherein the movement of the first source of sound is perceived as movement along a sound path.

6. The method of claim 5, wherein at least a portion of the sound path extends through the listener.

7. The method of claim 5, wherein the movement of the first source of sound is perceived as movement along one of a continuous sound path or a discontinuous sound path.

8. The method of claim 1 further comprising:
providing a third sound signal to one ear of the listener, wherein the third sound signal is different from the first and second sound signals; and
providing a fourth sound signal to the other ear of the listener, wherein the fourth sound signal is different from the first, second, and third sound signals and when provided with the third sound signal causes the listener to perceive a second source of sound moving about the listener in a manner that is different from the first source of sound.

9. The method of claim 8, wherein providing the first and second sound signals is terminated before providing the third and fourth sound signals such that the listener perceives only the second source of sound.

10. The method of claim 8, wherein providing the third and fourth sound signals occurs while providing the first and second sound signals such that the listener perceives both the first and second sources of sound simultaneously.

11. The method of claim 8, wherein the second source of sound is perceived to follow a sound path that is different than a sound path of the first source of sound.

12. The method of claim 8, wherein the second source of sound is perceived to move at a frequency or an angular movement that is different than a frequency or an angular movement of the first source of sound.

13. The method of claim 1 further comprising:
adjusting an amplitude of at least one of the first and second sound signals.

14. The method of claim 1, wherein providing the first and second sound signals further comprises:
supplying the first sound signal to a first channel of a headphone set; and
supplying the second sound signal to a second channel of the headphone set.

15. A binaural sound system comprising:
a first sound signal comprising a frequency that is modulated with a first phase to mimic repeated movement of a tone source as perceived by one ear of a listener; and
a second sound signal comprising the frequency that is modulated with a second phase that is different from the first phase to mimic movement of the tone source as perceived by the other ear of the listener.

16. The binaural sound system of claim 15, wherein the movement generates a tremolo effect.

17. The binaural sound system of claim 15, wherein the repeated movement is perceived as movement along a sound path.

18. The binaural sound system of claim 17, wherein at least a portion of the sound path extends through the listener.

19. The binaural sound system of claim 17, wherein the repeated movement is perceived as movement along one of a continuous sound path or a discontinuous sound path.

20. The binaural sound system of claim 17, wherein the repeated movement of the tone source forms a curvilinear path as the sound path.

21. The binaural sound system of claim 20, wherein the curvilinear path is one of an open path or a closed path about the listener.

22. The binaural sound system of claim 15, wherein the listener perceives a plurality of moving tone sources.

23. The binaural sound system of claim 22, wherein each of the plurality of moving tone sources differs in a path of movement, a frequency, an angular movement, or combinations thereof.

24. A method of altering a state of consciousness comprising:
disrupting a first state of consciousness to induce a second state of consciousness by listening to a binaural signal comprising:
a first sound signal supplied to a first sound channel, wherein the first sound signal comprises a frequency that is modulated with a first phase to mimic repeated movement of a tone source through a spatial angle or as a tremolo effect as perceived by one ear of a listener; and
a second sound signal supplied to a second sound channel, wherein the second sound signal comprises the frequency that is modulated with a second phase that is different from the first phase to mimic repeated movement of the tone source through a spatial angle or as a tremolo effect as perceived by the other ear of the listener; and
continuing listening to the second binaural signal to stabilize the second state of consciousness.

25. The method of claim 24, wherein the first state of consciousness is awake and the second state of consciousness is one of sleep, relaxation, concentration, or meditation.

26. The method of claim 24, wherein disrupting the first state of consciousness further comprises:
providing a secondary stimulus, the secondary stimulus being a naturally or artificially generated sound, a verbal guidance, an environmental condition, a social-psychological condition, or a combination thereof.

27. A binaural sound system comprising:
a first sound signal supplied to a first channel, the first sound signal being comprised of an emitted tone frequency; and
a second sound signal supplied to a second channel, the second sound signal being comprised of the emitted tone frequency that is phase shifted relative to the first sound signal.

28. The binaural sound system of claim 27, wherein the shifted phase is configured to be perceived as a tremolo effect by a listener.

29. The binaural sound system of claim 27, where the shifted phase is configured to be perceived as movement of the emitted tone frequency along a sound path.

30. The binaural sound system of claim 29, wherein at least a portion of the sound path extends through a listener.

31. The binaural sound system of claim 29, wherein the sound path is one of a continuous sound path or a discontinuous sound path.
